(19) United States
(12) Patent Application Publication
(10) Pub. No.: US 2008/0004015 A1
(43) Pub. Date: Jan. 3, 2008

(54) Customer experience tracking from remote mobile communication network equipment

(76) Inventors: Stewart R. Jones, Superior, CO (US); Richard B. Whitner, Fort Collins, CO (US); Judith C. Walker, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/479,851

(22) Filed: Jun. 30, 2006

(51) Int. Cl. H04Q 7/20

(52) U.S. Cl. 455/435.1

(57) ABSTRACT

A parameter measurement system is provided, for measuring parameters accessible by mobile equipment, employed by a customer of a service provider, which communicates over a communication network. Communication network apparatus provides communication between the mobile equipment and the service provider. The system comprises an agent which includes measurement apparatus for taking measurement values of parameters of operation of the mobile equipment related to the customer's experience using the mobile equipment, and processing apparatus for generating data records of the measured parameters. The system further comprises a transmitter for transmitting the data records over the communication network to the service provider.

The invention is related to the following co-pending U.S. patent applications:

Ser. No. 11/375,805, filed Mar. 14, 2006

Ser. No. 11/375,793, filed Mar. 14, 2006

Ser. No. 11/397,082, filed Apr. 3, 2006

Ser. No. 11/397,141, filed Apr. 3, 2006

### BACKGROUND OF THE INVENTION

The present invention relates to the field of telecommunications, and particularly to wireless cellular telephone (“cell phone”) networks.

In a typical communications architecture, users are coupled for communication with one or more mobile network infrastructure components, such as nodes, base stations, servers, etc., which, in turn, are coupled for communication with public communication networks such as the Internet. A given service provider uses its base stations, etc., to support a respective technology coverage area. Communications between such users pass through the service providers' respective base stations, and across the public networks. Such users employ mobile equipment such as cellular telephones.

A given service provider (“home service provider”) will provide its customers with a respective menu of available services and operating parameters. Within the home service provider's technology coverage area, the home service provider has access to data regarding the services provided to its customers. Much of this data will pertain specifically to the home service provider, as distinct from other service providers on the network. The home service provider accesses the data by monitoring the various cellular system infrastructure components in the network.

Service providers conventionally have used specialized test equipment and performed “drive” tests to measure network performance both inside and outside of their respective technology coverage areas. Home service providers conduct surveys of their customers to understand, for instance, the level and quality of service available from other service providers outside of the home service provider's technology coverage area. Test labs are also set up to simulate the expected environments. However, these methods have had the drawback that they cannot directly measure customer experience.

This drawback also becomes important as the customer's mobile equipment gains the capability to “roam,” i.e. to move from place to place, into technology coverage areas that are supported by service providers different from the home service provider, or that provide different technologies (for instance, GPRS and WiFi). For instance, a customer of the service provider might use a GPRS mobile phone that is capable of switching between the home service provider's GPRS network and another service provider's GPRS network.

Such other service providers conventionally offer no insight to the home service provider as to the level of service the customer is receiving from other service providers. This inaccessibility, to the home service provider, of information on the customer's experience disadvantageously limits the home service provider's ability to provide the customer with effective support. The service provider also will have a difficult choice between other service providers as partners, because the home service provider has little access to information on which service provider will provide their customers with the best level of service.

Current solutions monitor traffic on the network, or have external devices run active tests on the network to determine service quality. No product exists today which measures the direct true customer quality on the final end device, and which packages this information up into customer quality records.

### SUMMARY OF THE INVENTION

A parameter measurement system is provided, for measuring parameters accessible by mobile equipment, employed by a customer of a service provider, which communicates over a communication network. Communication network apparatus provides communication between the mobile equipment and the service provider. The system comprises an agent which includes measurement apparatus for taking measurement values of parameters of operation of the mobile telephone equipment related to the customer's experience using the mobile equipment, and processing apparatus for generating data records of the measured parameters. The system further comprises a transmitter for transmitting the data records over the communication network to the service provider.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram showing an example of a communications architecture, within which embodiments of the invention are practiced.

FIG. 2 is a block diagram showing a more detailed implementation of a piece of mobile equipment in accordance with an embodiment of the invention.

FIGS. 3 and 4 are flowcharts showing operation of a method according to an embodiment of the invention.

FIG. 5 is a diagram of a graphical user interface according to an embodiment of the invention.

### GLOSSARY

For the description of the present invention, the following terms shall have the meanings here set forth:

“Agent” means a piece of autonomous or semi-autonomous proactive and reactive computer software residing on the mobile device. Many individual communicative software agents may form a multi-agent system.

“Base Station” means a network node, server, etc., generally provided and operated by a service provider, for facilitating user communication over a communication network.

“Customer” means an individual or other party who possesses communication equipment, such as a cell phone or laptop computer, and who subscribes with a home service provider for network communication services. The terms “user” and “mobile user” are used interchangeably with “customer.”

“Home service provider” means, with reference to a given customer, a service provider with which the customer has a subscription for network communication service.

“Mobile equipment” or “mobile device” means a piece of equipment, owned or possessed by a customer of a service provider, or by the service provider and their employees (“user”), having capability of communicating over the communication network, and which the user can, pursuant to the use of the mobile equipment, transport the mobile equipment from place to place and use it in those respective places. The terms “mobile device” and “mobile equipment” are used interchangeably.

“Networking technology” means a communication technology, standard, protocol, format, etc, which a given service provider employs to enable communication over a communication network. Examples of networking technologies include General Packet Radio Service (GPRS) and Integrated Enhanced Digital Network (IDEN).

“Service” or “Service Offering” means, broadly, a resource provided by a home service provider to its customers.

“Service provider” means a party which maintains equipment and means for transmitting and receiving communications over a communication network, and which offers subscriptions to customers, pursuant to which the customers and other communication network users utilize the service provider's equipment and means for transmitting and receiving, to communicate over the communication network.

### DETAILED DESCRIPTION

Delivering services of high quality, predominantly voice services but increasingly data services, is a significant objective for providers of telecommunications services such as cell phone services. To facilitate quality services, service providers employ information about the performance of their service offerings, and of their customers' mobile equipment as the customers use the service offerings. This information is also of value for troubleshooting.

Monitoring and troubleshooting service quality involves measuring many parameters from a variety of sources, and correlating those measurements into meaningful records for reporting and analysis. Measurements collected from the mobile equipment itself provide direct insight into the service quality that customers are actually experiencing.

Systems and methods embodying this invention create service detail records, that include correlated measurements collected on mobile equipment during actual service activity. The service detail records can be used by service providers such as cell phone operators to monitor and troubleshoot service quality within their service offerings and on their networks.

The invention has applicability to mobile cellular telephone communication systems and networks, and much of the discussion which follows will focus on examples directed to such systems and networks. It will be understood, however, that the invention also has applicability to a broader range of technologies related to data communications, such as measuring and reporting the performance of data transmission during a customer data session.

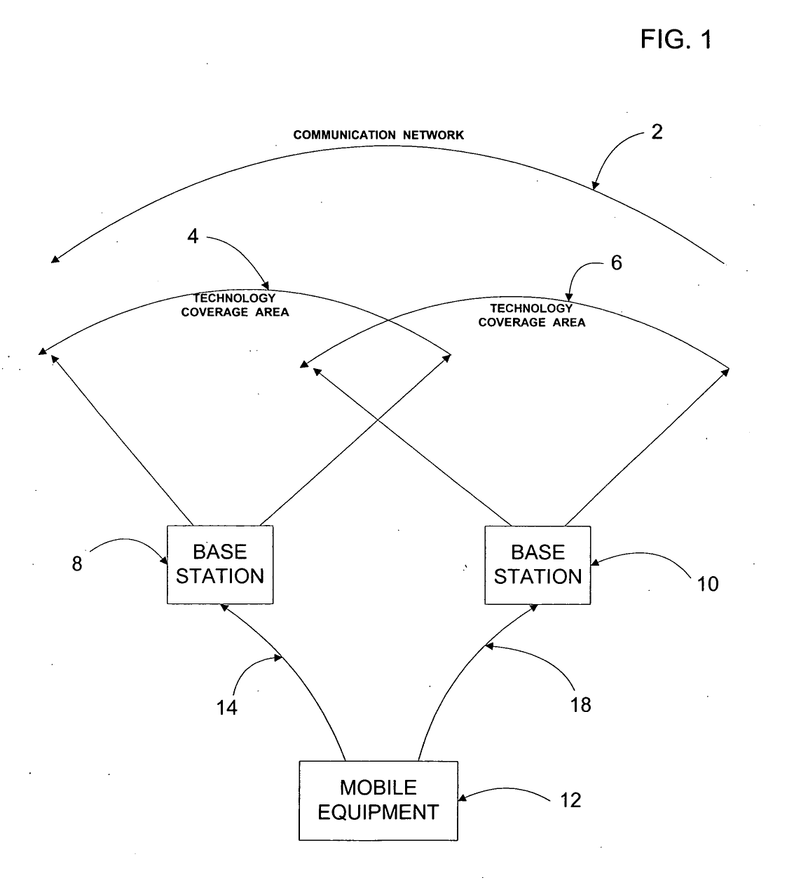

An example of an environment, in which various embodiments of the invention may be practiced, is illustrated by the block diagram of FIG. 1. A communication network 2 covers a region, such as a geographical region, over which first and second service providers provide coverage within respective technology coverage areas 4 and 6.

Mobile network infrastructure equipment, shown for instance as base stations 8 and 10, are provided, within the respective technology coverage areas 4 and 6, to facilitate user communications. While the invention will be described primarily in terms of the example of FIG. 1 and its related discussion, it will be understood that this does not limit the scope of architectures to which the invention applies. A variety of other types of network infrastructure equipment familiar to persons skilled in the art, for instance nodes, base stations, servers, etc., may also be implemented within architectures to which the invention applies.

A customer of the first service provider, using mobile equipment 12 such as a cell phone, communicates with the base station 8 for access to the communication network 2 by means of a wireless or other communication link 14.

For the purpose of describing the invention, the first service provider will be referred to as the “home service provider,” as per the definition in the Glossary, above. As the mobile equipment 12 travels into a different technology coverage area, it communicates, for instance through a link 18, with the base station 10, and over the communication network 2 to the home service provider.

The home service provider includes a store of information regarding the provided services, and customers' history of experience using the services. As parameter measurement value information is accumulated and transmitted to the home service provider from the mobile equipment 12 in a manner described below, the reported information is added to the store.

The mobile equipment 12 includes, among its various possible embodiments, a processor, memory, and a wireless communication interface. For instance, the mobile equipment 12 might include a laptop computer, cell phone, handheld “personal digital assistant” unit, or wireless sensor. The invention will be described, without limitation, in terms of an example of the mobile equipment 12, comprising a cell phone.

In one embodiment of the invention, measurements are made at the location where the mobile equipment 12 is, and at the time when the customer is using the mobile equipment 12. The measurements are taken at, or on-board, the mobile equipment 12. Thus, the home service provider has clear visibility of the customer's experience as the customer uses the mobile equipment 12. As a consequence, a much better representation of customer experience is provided, than with conventional systems, which do not make this information available to the service providers.

The mobile equipment 12 further includes apparatus, which may be implemented as a software agent, for measuring parameters, changing the parameters to be measured, and preparing and sending parameter measurement reports. Embodiments of the agent will be described in detail herebelow.

An embodiment of the invention includes the following:

A. Software agent installed or installable on the mobile equipment
1. Agent is capable of communicating with a home service provider's server.
2. Agent is capable of storing measurements for some period of time.
3. Agent is capable of making measurements useful to the home provider.

B. Server to configure agents and collect data.

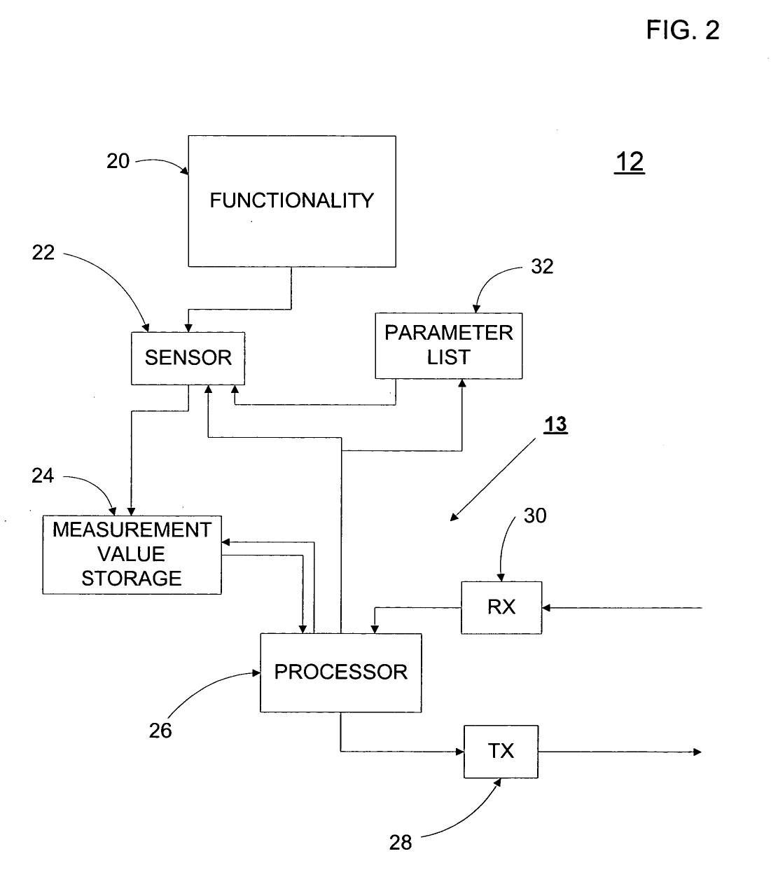

FIG. 2 is a block diagram of the piece of mobile equipment 12 of FIG. 1, such as a cell phone, illustrating one embodiment of the invention.

The mobile equipment 12 has a general functionality 20, whose nature depends on what type of equipment it is. For instance, if the mobile equipment 12 is a cell phone, then its general functionality 20 would include voice telecommunications apparatus and a user interface including a mouthpiece with microphone, an audio speaker, and a keypad. The user interface is not separately shown in FIG. 2, but is understood generally to be part of the general functionality 20.

The embodiment of the invention further includes an agent 13, which may be implemented in software that is executed on-board the mobile equipment 12, and which directs the mobile equipment 12 to operate, for instance, as described in detail herebelow.

The mobile equipment 12 operates in various modes (such as in various communication technologies, etc.) and functions (such as receiving a message or call, sending a message or call, transmitting, receiving, waiting in an idle state, receiving or displaying information through an on-board user interface, etc.).

Depending on the occurrence of interest (such as the beginning or ending of a call, etc.) or on the mode, function, etc., within which the mobile equipment 12 is operating at any given time, the operation of the mobile equipment 12 will be such that a respective set of operating parameters will be of interest.

In an embodiment of the invention, measurement values of such operating parameters are taken as the mobile equipment 12 operates. In the embodiment of FIG. 2, an apparatus for taking the measurement values of the operating parameters is shown schematically as a sensor 22. The sensor 22 is broadly understood to include suitable implementations for taking the measurement values of the operating parameters, and may include suitable hardware sensors and interfaces, suitable software implemented as part of the agent 13, etc.

As the mobile equipment 12 operates, the measurement values of the operating parameters that are taken by the sensor 22, are stored in measurement value storage 24. A processor 26 handles the parameter measurement values by processing, formatting, and/or packetizing, and transmits them, through a transmitter including a transmit interface 28, over the communication network. The parameter measurement values may be transmitted in the form of call record data packets, whose form and content will be described below.

In another embodiment of the invention, a receive interface 30 receives signals from the network, which may, for instance, include a command to sense measurement values of parameters designated by the home service provider. Alternatively, such command signals can come from the user interface portion of the general functionality 20, when the user enters a command to select a function. The signals are provided to the processor 26, which interprets the signals appropriately, to identify which parameters are to be sensed.

The processor 26 then accesses a parameter list 32, which contains sets of parameters that are appropriate for various configurations or functions of the mobile equipment 20, etc. The processor 26 then configures the sensor 22, to take measurement values of the parameters to be sensed. In so doing, the processor 26, operating as per the programming of the agent 13, serves as a selector for selecting parameters for measurement.

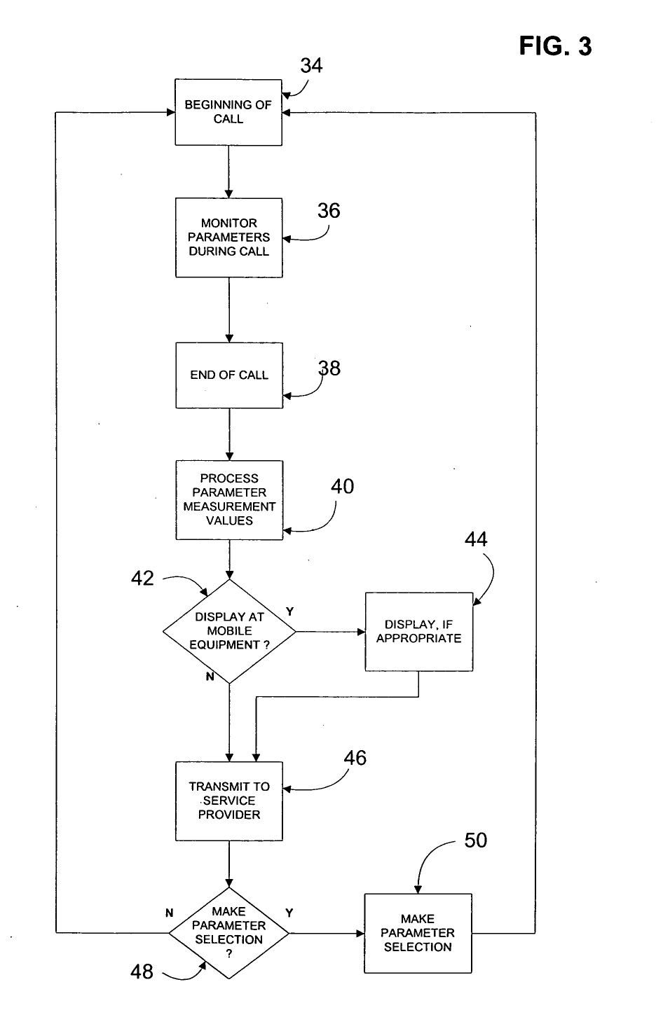

FIG. 3 is a flowchart of a method of operation of the mobile equipment 12, according to an embodiment of the invention. When the agent 13 is implemented in software, the implementation causes the mobile equipment 12, such as that shown in FIG. 2, to operate as described in the flowchart of FIG. 3, with reference to the text which follows.

The agent 13 operates to detect events or activities, for which measurement values of operating parameters are to be monitored. For instance, in a cell phone embodiment, the detection of an activity to be monitored might be the beginning of a cell phone call (block 34 of the flowchart). Detection of such activity initiates monitoring, and parameters are monitored as the call proceeds (36). Eventually the call ends (38), after which time the agent 13 will have captured a batch of measurement values of the operating parameters monitored from the call.

The agent 13 then processes the monitored measurement values (40). Such monitoring can include statistical computations, formatting for display presentation, etc. In particular, it includes preparation for transmission across the communication network 2 to the home service provider, such as formatting into call record packets for transmission.

In one embodiment, measurements associated with a particular activity, such as a phone call, can be accumulated and reported on as a unit that spans the full duration of the call. More generally, measurements can be collected and reported at the occurrence of an event and over the duration spanning multiple defined events, such as the start and end of a call or data session.

Optionally, the monitored parameter measurement values can be displayed at the mobile equipment 12 itself. This can be in response to user command, or automatically if the mobile equipment 12 is configured to display the parameter measurement values automatically. In operation, the agent 13 tests whether such a condition for displaying the measurement values at the mobile equipment 12 is met (42). If such a condition is in fact met, then they are displayed (44).

The measurement values resulting from the parameter monitoring are transmitted to the home service provider (46). The agent 13 prepares reports of the parameter measurement values it has monitored and detected. The agent 13 sends the parameter reports at specified intervals, in response to requests from the home service provider received over the communication network 2 through the receive interface 30, in response to predetermined values of predetermined parameters when the predetermined values are sensed, as the parameters are sensed, in response to accumulation of a predetermined quantity of parameters, or at other times which the system architect may choose.

Sensed parameter measurement values from the mobile equipment 12 are reported from the mobile equipment 12 to a data collection server of the home service provider, via the base stations 8 and/or 10 and the communication network 2. The parameter measurement value report is transmitted (46), for instance through the transmit interface 28.

For instance, in the implementation of FIG. 3, the parameters are accumulated until one of the above-stated conditions is met. If it is not yet time to send the parameter report, then parameter sensing continues. If it is time to send a report, then the agent 13 prepares a parameter measurement value report (40), such as a call record. For instance, in one embodiment the processor 26 prepares the report, by following its pre-programmed instructions and/or the agent 13's configuration settings. Preparing the report may include packaging the sensed measurement values into a data packet for transmission. pre-processing the measurement values, etc. Pre-processing may include summarizing the sensed measurement values, calculating statistics, averaging, flagging noteworthy sensed measurement values such as deviations beyond a threshold normal value, etc.

The agent 13 continues sensing the parameter measurement values, storing and accumulating the sensed measurement values, etc., for instance by returning to (34) if and when another call takes place.

The agent 13 also can select parameters to monitor, either by user command into the user interface of the mobile equipment 12, or by command transmitted from the home service provider over the communication network 2. Parameter selection is not necessarily coincident in time with call monitoring or measurement value reporting. However, for convenient explanation the flow chart of FIG. 3 additionally shows a test (48) for a condition (such as user configuration or command receipt from the home service provider) for reconfiguring which parameters are to be monitored.

If such a condition is not met, then the agent 13 resumes monitoring parameters as above. When such a condition does occur, the agent 13 selects parameters (50) from the parameter storage 24, and configures the mobile equipment 12 for monitoring the selected parameters.

For example, a Call Record of measurements that may be taken by an agent within a GPRS network include, but are not limited to:

IMEI (International Mobile Equipment Identity) (equipment identifier)

IMSI (subscriber identifier)

Operating system

Calling MSISDN

Called MSISDN

Call start event record

Call end event record

Call connect duration

Call release code

List of event records for other events occurring during the call

Each event record, for instance, may contain the following:

Event time

MCC (mobile country code)

MNC (mobile network code)

LAC (location area code)

Cell ID

Latitude

Longitude

Network type

Signal strength

Battery level

Memory usage

Codec used

Event records may be triggered by any of the following:

Call start

Call end

MCC change

MNC change

LAC change

Cell ID change

Network type change

Signal strength drops below a defined threshold

Battery level drops below a defined threshold

Memory usage increases above a defined threshold

Codec change

Other data can be collected, e.g. more radio specific parameters such as neighboring cells, channel utilization, etc. Data collected might also vary, e.g. cell ID information will be different for CDMA networks.

Other event triggers can be defined, e.g. GPS parameters change, radio network parameters change, etc.

It should be noted that, in some contexts relating to voice telephony, the term “voice call quality” has a specific meaning, and applies to certain specific metrics. In the context of the invention, however, a broad spectrum of service performance, including but not limited to voice call quality thus understood, may be measured and reported on.

These measurements may be used by the home service provider for many different applications, such as verification of service performance or planning for extensions to service coverage. This system could also be used to decrease new service time-to-market by deploying these agents to friendly users or home service provider employees to increase the provider's data points on performance and therefore confidence in the service being deployed. The measurements can also be used for troubleshooting customer service problems.

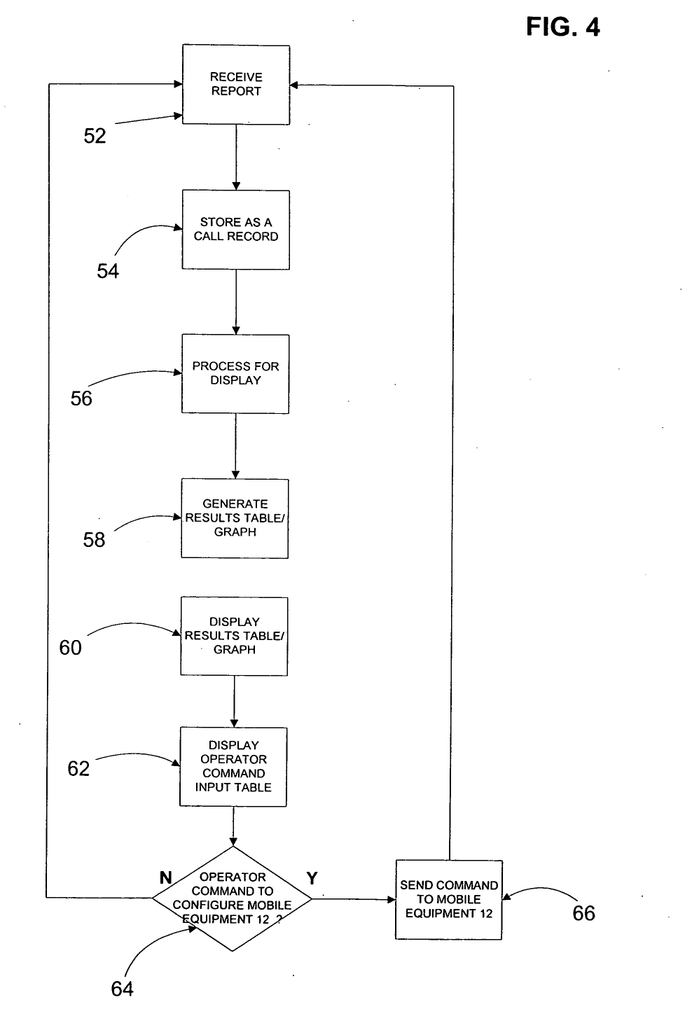

FIG. 4 is a flowchart showing operation at the home service provider, receiving and employing the measurement value reports sent from the mobile equipment 12.

The home service provider receives (52) a parameter measurement value report, transmitted from the mobile equipment 12. The report is stored as a call record (54) in the home service provider's store.

The call record, either alone or in combination with other call records from the same mobile equipment or with call records from other pieces of mobile equipment, is processed for display (56). Such processing can include calculation of statistics, formatting into a suitable visual representation such as a table, graph, histogram, pie chart, etc.

In one embodiment, the processing for display includes generating a results table, which may alternatively include a graph (58). The generated results table and/or graph are then displayed to the home service provider's operator (60). The home service provider may include a user interface system, such as a video monitor, printer, etc., that will allow the home service provider's operator to request and obtain such results information on demand.

In one embodiment of the invention, detailed graphical displays of measurement values can be provided, to assist the home service provider in analyzing the measurement values. Such displays of measurement values can be provided either at the mobile equipment 12 through a suitable user interface, as well as at the home service provider. If the measurement values are displayed at the mobile equipment 12, then data processing and display may be part of the functionality of the agent 13. Graphical displays, etc., of the mobile equipment 12 may be used to show the display. The measurement values may be displayed for a given session, for instance at the conclusion of a cell phone call. Alternatively, they may be accumulated for several calls, and displayed in summary form.

Also, the displays of measurement values may be provided at the home service provider. For instance, a display screen or other user interface, located at the home service provider, may be used to display such measurement values. In particular, the home service provider's operator user interface may include a set of input fields for allowing the operator to enter a request for a summary or statistical report of the measurement values obtained and stored from the home service provider's users' mobile equipment.

The home service provider operator may also enter commands, either to display the information as described above, to run queries on the call record data accumulated within the home service provider's store, or to send remote commands to the mobile equipment 12 for either data querying or remote parameter reconfiguration.

This is illustrated in FIG. 4, in that an operator command input table is displayed (62). This is a user interface, that enables the home service provider operator to enter appropriate commands. The entered command may be to reconfigure the mobile equipment 12 (64), such as to change monitored parameters, change the operating function of the mobile equipment 12, to request a time- or function-specific report, etc. In such case, an appropriate command is sent (66) to the mobile equipment 12. When the mobile equipment 12 receives such command, it may, for instance, reconfigure its parameter monitoring, as per (48) and (50) in FIG. 3, as described above.

The operations, as described in connections with FIGS. 2-4, provide a wide range of flexibility, for the home service provider operator to select a given customer, one or more calls or other service transactions over a period of time, etc. Alternatively, the system may accumulate, process and display measurement values from multiple users across a population of similarly situated customers, etc.

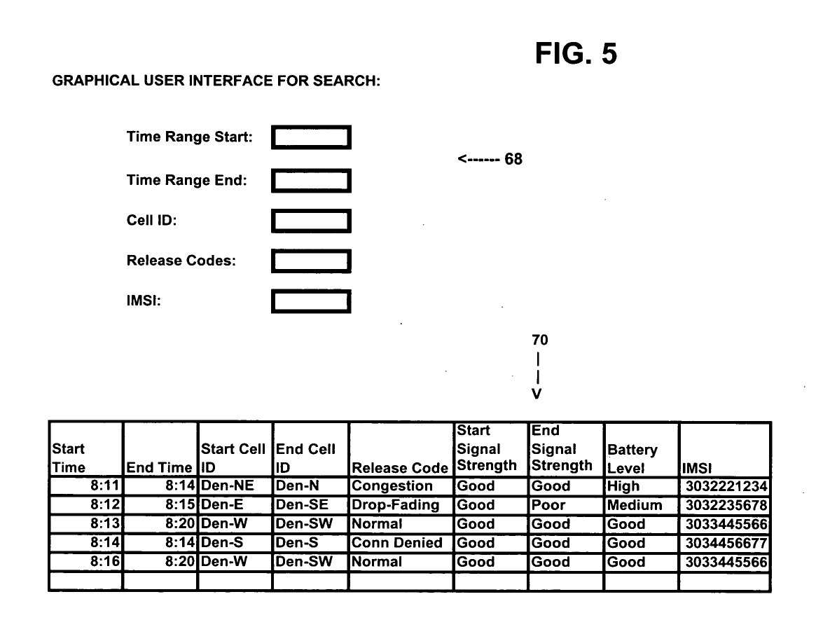

One possible form of graphical results display is illustrated in FIG. 5. A user input section, generally show as 68, provides input fields, to enable a user to select various parameters for a report that is to be generated and displayed. The report is shown as a table 70.

Conventionally, the service provider would normally be blind to the performance the user is experiencing. However, because the measurements are being taken from the mobile equipment 12, the customer is independent of the network, and the measurements can be provided back to the home service provider's system. This data may be used by the home service provider for many different applications, such as verification of network service performance and verification or planning for extension to network coverage.

Because these agents (e.g., the agent 13) may be employed on a large number of mobile devices, some implementations likely will encounter issues with scaling. Conventionally, installing agents on all of a service provider's customer devices would lead to a solution that could not scale. Also, because the agents will reside on consumer devices, there will be issues with privacy. Systems and methods which include embodiments of the present invention may advantageously address these issues, by employing techniques, such as those disclosed in the U.S. patent applications here listed:
Ser. No. 10/047,240 Method and System for Improved Monitoring Measurement and Analysis of Communication Networks Utilizing Dynamically and Remotely Configurable Probes
Ser. No. 10/736,653 Wireless Probe Management System
Ser. No. 11/230,774 Technique for Management Allowing Anonymous Probe Configuration Allowing Anonymous Probe Identity
Ser. No. 11/230,895 Selective Distribution Of Measurement Device Behavior In a Loosely Coupled Autonomous System
Ser. No. 09/884,353 Configuring Devices Using Server Responses
Ser. No. 10/698,292 Bandwidth Management Using Statistical Measurement
Ser. No. 10/306,940 Systems and Methods for Measurement and/or Control Using Mobile Probes
Ser. No. 10/829,091 Methods and devices for configuring mobile applications based on specifications defining regions in multidimensional coordinates.
Ser. No. 09/020,630 Transducers with Electronic Data Sheets That Enable Transducer Access Using Multiple Type of Transducer Object Models
Ser. No. 10/909,051 Method and System for Treating Events and Data Uniformly

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A parameter measurement system, for measuring parameters accessible by mobile equipment which communicates over a communication network, the communication network including a service provider and communication apparatus for providing communication between the mobile equipment and the service provider, the mobile equipment being employed by a customer of the service provider, the customer having an experience using the mobile equipment, the system comprising:
an agent which includes:
(i) measurement apparatus for taking measurement values of parameters of operation of the mobile equipment related to the customer experience, and
(ii) processing apparatus for generating data records of the measured parameters; and
a transmitter for transmitting the data records over the communication network to the service provider.

2. A system as recited in claim 1, wherein the mobile equipment includes a cellular telephone.

3. A system as recited in claim 1, wherein:
the mobile equipment includes a processor and a sensor for sensing the measurement values of the parameters; and
the agent is implemented within the mobile equipment as software for execution by the processor.

4. A system as recited in claim 1, wherein:
the mobile equipment includes parameter storage for accumulating measurements of the parameters; and
the agent generates data records from the measurements as the measurements accumulate, and stores the data records in the parameter storage.

5. A system as recited in claim 4, wherein:
the agent stores the data records for one of (i) a predetermined period of time, (ii) until a predetermined quantity of data records have been accumulated, (iii) until a predetermined event occurs, and (iv) until a request for transmission of the data records is received; and
upon occurrence of the one of the foregoing, the agent transmits the stored data records to the service provider.

6. A system as recited in claim 1, wherein:
the agent includes a parameter list of parameters selectable for measurement, the parameter list including sets of parameters suitable for different services; and
the system further comprises a selector for selecting a service and configuring which set of parameters is to be measured based on the selected service.

7. A system as recited in claim 6, wherein one of:
(i) the selector is operable responsive to a command to select a parameter set for measurement, the command being received from the service provider over the communication network;
(ii) the selector is operable responsive to a sensed condition; and
(iii) the mobile equipment includes a user interface to enable the customer to select a service, and the selector is operable responsive to selection of a service by the customer.

8. A system as recited in claim 1, wherein:
the customer uses the mobile equipment for voice communication over the communication network;
the customer experience includes an experience of quality of voice service; and
the predetermined parameters of operation pertain to the quality of voice service experienced by the customer.

9. A system as recited in claim 1, further comprising a processor for preprocessing the measured parameters before transmitting the measured parameters.

10. A system as recited in claim 9, wherein:
the mobile equipment includes a display, and
the agent displays a report of the parameter measurement values on the display.

11. A system as recited in claim 1, wherein the service provider includes a node, coupled to the communication network to receive the measured parameters transmitted from the agent, the node including a user interface for use by a service provider operator, the user interface including a graphical display, for displaying a report of the customer experience based on the data records.

12. A system as recited in claim 11, wherein the report is displayed in the form of one of (i) a graph, and (ii) a table.

13. A system as recited in claim 13, wherein the user interface includes a user input interface, to allow the service provider operator to enter one of (i) a query for a report based on the stored data records, and (ii) a command to be transmitted to the mobile equipment.

14. A method for measuring parameters accessible by mobile equipment which communicates over a communication network, the communication network including a service provider and communication apparatus for providing communication between the mobile equipment and the service provider, the mobile equipment being employed by a customer of the service provider, the customer having an experience using the mobile equipment, the method comprising:
taking measurement values of parameters of operation of the mobile equipment related to the customer experience,
generating data records of the measured parameters; and
transmitting the data records from the mobile equipment over the communication network to the service provider.

15. A method as recited in claim 14, further comprising generating data records from the measurements as the measurements accumulate, and storing the data records.

16. A method as recited in claim 15, further comprising:
storing the data records for one of (i) a predetermined period of time, (ii) until a predetermined quantity of data records have been accumulated, (iii) until a predetermined event occurs, and (iv) until a request for transmission of the data records is received; and
upon occurrence of the one of the foregoing, transmitting the stored data records to the service provider.

17. A method as recited in claim 14, further comprising:
selecting a service for operation by the mobile equipment, the service having associated therewith a set of parameters suitable for the selected service; and
configuring the mobile equipment to measure the associated set of parameters.

18. A method as recited in claim 17, wherein one of:
(i) the selecting and the configuring are operable responsive to a command to select a parameter set for measurement, the command being received from the service provider over the communication network;
(ii) the selecting and the configuring are operable responsive to a sensed condition; and
(iii) the mobile equipment includes a user interface to enable the customer to select a service, and the selecting and the configuring are operable responsive to selection of a service by the customer.
